(19) United States
(12) Patent Application Publication
(10) Pub. No.: US 2026/0081761 A1
(43) Pub. Date: Mar. 19, 2026

(54) DATA TRANSMISSION METHOD AND APPARATUS, COMPUTER DEVICE, AND COMMUNICATION SYSTEM

(71) Applicant: HUAWEI TECHNOLOGIES CO., LTD., Shenzhen (CN)

(72) Inventors: Yang Zhao, Dongguan (CN); Yong Li, Darmstadt (DE); Xiaoqing Xie, Dongguan (CN); Han Gao, Dongguan (CN)

(73) Assignee: HUAWEI TECHNOLOGIES CO., LTD., Shenzhen (CN)

(21) Appl. No.: 19/393,294

(22) Filed: Nov. 18, 2025

Related U.S. Application Data
(63) Continuation of application No. PCT/CN2024/093161, filed on May 14, 2024.

(30) Foreign Application Priority Data
May 19, 2023 (CN) 202310572263.9

(51) Int. Cl. H04L 9/08; H04L 9/30

(52) U.S. Cl. CPC H04L 9/0822; H04L 9/3066

(57) ABSTRACT

A method includes: generating an authentication key based on a security credential distributed by an authentication center. Mutual authentication is performed between devices based on authentication code, where that authentication code is generated based on the authentication key. Encrypted data is obtained by encrypting with an encryption key.

### CROSS-REFERENCE TO RELATED APPLICATIONS

This application is a continuation of International Application No. PCT/CN2024/093161, filed on May 14, 2024, which claims priority to Chinese Patent Application No. 202310572263.9, filed on May 19, 2023. The disclosures of the aforementioned applications are hereby incorporated by reference in their entireties.

### TECHNICAL FIELD

This application relates to the communication field, and in particular, to a data transmission method and apparatus, a computer device, and a communication system.

### BACKGROUND

With the development of internet of things, a quantity and types of internet of things devices have increased accordingly. Because resources (for example, storage resources and computing power resources) of internet of things devices are limited, conventional authentication mechanisms cannot be used to authenticate the internet of things devices. Consequently, the internet of things devices provide a physical environment for network attacks, making the internet of things highly vulnerable to network attacks, resulting in frequent communication security incidents.

### SUMMARY

This application provides a data transmission method and apparatus, a computer device, and a communication system, to implement security authentication on an internet of things device with constrained resources, reduce network attacks on an internet of things, and improve network security of the internet of things.

According to an aspect, a data transmission method is provided, and includes:
generating an authentication key based on a security credential distributed by an authentication center; and after mutual authentication between devices is performed based on authentication code generated based on the authentication key, transmitting encrypted data obtained by encrypting with an encryption key.

During symmetric key encryption, the authentication center needs to store a shared key, and transmission of the shared key needs to be performed between the devices. It is difficult to manage the shared key and the shared key is easy to be obtained, resulting in network attacks. During asymmetric key encryption, a certificate and a public key occupy large network bandwidth and more storage resources. In comparison, according to the solution provided in this application, authentication is performed based on the generated authentication key, and transmission of the authentication key does not need to be performed between the devices, to reduce occupied bandwidth, avoid obtaining of the authentication key, improve security of the authentication key, and reduce network attacks. The authentication center does not need to manage the authentication key or the security credential, so that an authentication mechanism is decentralized, and complexity of key management is reduced. In addition, a data amount of the authentication key is small, and a storage requirement of an internet of things device with constrained resources is satisfied. Therefore, security authentication on the internet of things device with constrained resources is implemented, network attacks on an internet of things are reduced, and network security of the internet of things is improved.

In an embodiment, the method further includes: generating the encryption key based on the security credential. Therefore, security of the encryption key is improved.

In an embodiment, generating the authentication key based on the security credential includes: according to an elliptic curve cryptography, generating the authentication key based on the security credential. The elliptic curve cryptography has advantages of high security, a high processing speed, small occupied storage space, and small bandwidth that needs to be occupied. Therefore, the authentication key is generated according to the elliptic curve cryptography, so that a calculation amount is small, a data amount of the authentication key is small, lightweight security authentication on an internet of things device in an internet of things is implemented, and a resource performance requirement of the internet of things device is satisfied.

In an embodiment, generating the authentication key based on the security credential includes: generating a public key of a second device based on a public key of the authentication center and the security credential; and generating the authentication key based on the public key of the second device and a private key of a first device.

In this way, the public key of the devices is generated based on a hash function according to the elliptic curve cryptography, and the authentication key is generated based on the public key of the devices. In other words, a same authentication key is generated based on different input parameters according to an asymmetric encryption algorithm. Transmission of the public key and the authentication key does not need to be performed between the devices, to avoid obtaining of the public key and the authentication key by an unauthorized device (for example, an attack device), and improve security of the public key and the authentication key.

In an embodiment, the method further includes: calculating an identifier of the first device and a random number based on the authentication key, to generate the authentication code. Because the random number is used as an input parameter for generating the authentication code, security of the authentication code is improved.

In an embodiment, the security credential includes at least one of an identifier of the authentication center, a security parameter, a hash function, and an elliptic curve identifier.

In an embodiment, the method further includes: when verifying the security credential as valid, generating a public key and the private key of the first device based on the security credential.

In an embodiment, verifying the security credential as valid includes: verifying the security credential as valid based on the public key of the authentication center, the identifier of the first device, and the identifier of the authentication center.

Therefore, security of a key is further ensured by verifying the security credential, and a case in which a public key and a private key of a device are generated by using an invalid security credential is avoided.

In an embodiment, the method further includes: updating the public key and a private key of the authentication center; or updating the public key and the private key of the first device.

In this way, based on a key update mechanism, a key is updated before a life cycle of the key ends, or when it is known or possible that the key is leaked, to improve security of the public key and the private key of the device, the security credential, the authentication key, and the encryption key in an internet of things.

In an embodiment, the method further includes: receiving a revocation request; and performing a revocation operation based on the revocation request. The revocation request includes a revocation list and a public key of an authentication device, and the revocation list includes the identifier of the first device.

According to an aspect, a data transmission method is provided. The method includes: receiving authentication code sent by a first device; when verification code generated based on a second authentication key is the same as the authentication code, determining that the first device is successfully authenticated; and receiving encrypted data sent by the first device. The authentication code is calculated based on a first authentication key that is generated based on a first security credential. The encrypted data is obtained by encrypting with a first encryption key, and the first encryption key is calculated based on the first security credential.

In this way, the authentication code sent by the first device is verified based on an authentication key generated by a second device, and transmission of the authentication key does not need to be performed between the devices, to avoid obtaining of the authentication key by an unauthorized device, and improve security of the authentication key. Two-way authentication is completed between the first device and the second device based on the authentication key, a data amount of ciphertext is small, and occupied bandwidth is reduced. Therefore, security authentication on an internet of things device with constrained resources is implemented, network attacks on an internet of things are reduced, and network security of the internet of things is improved.

In an embodiment, the method further includes: obtaining a second security credential from an authentication center; and generating the second authentication key based on the second security credential.

In this way, authentication is performed based on the generated authentication key, and transmission of the authentication key does not need to be performed between devices, to reduce occupied bandwidth, avoid obtaining of the authentication key, improve security of the authentication key, and reduce network attacks. The authentication center does not need to manage the authentication key or the security credential, so that an authentication mechanism is decentralized, and complexity of key management is reduced. In addition, a data amount of the authentication key is small, and a storage requirement of an internet of things device with constrained resources is satisfied. Therefore, security authentication on the internet of things device with constrained resources is implemented, network attacks on an internet of things are reduced, and network security of the internet of things is improved.

In an embodiment, the method further includes: generating the second authentication key based on the second security credential according to an elliptic curve cryptography.

In an embodiment, generating the second authentication key based on the second security credential includes: generating a public key of the first device based on a public key of the authentication center and the second security credential; and generating the second authentication key based on the public key of the first device and a private key of a second device.

In an embodiment, generating the verification code based on the second authentication key includes: calculating an identifier of the first device and a random number based on the second authentication key, to generate the verification code.

According to an aspect, a data transmission method is provided. The method includes: generating a first security credential based on a random number, an identifier of a first device, an identifier of an authentication center, and a private key of the authentication center; and feeding back the first security credential to the first device, where the first security credential is used by the first device to generate an authentication key and perform authentication with a second device.

In this way, the authentication center distributes the first security credential to the first device, so that the first device generates a public key and a private key of the first device, and the authentication key based on the security credential, to improve security of the key. The authentication center manages a public key and the private key of the authentication center, and does not need to manage the public key or the private key of the device, or the security credential, so that an authentication mechanism of an internet of things is decentralized, and complexity of key management is reduced.

In an embodiment, generating the first security credential based on the random number, the identifier of the first device, the identifier of the authentication center, and the private key of the authentication center includes: when verifying the first device as authorized, generating the first security credential based on the random number, the identifier of the first device, the identifier of the authentication center, and the private key of the authentication center.

In this way, after successfully verifying the first device that is to access an internet of things, the authentication center distributes the first security credential to the first device. Therefore, in a registration phase, the authentication center verifies the first device, to ensure security of distributing the security credential, and avoid distributing the security credential to an unauthorized device.

In an embodiment, generating the first security credential based on the random number, the identifier of the first device, the identifier of the authentication center, and the private key of the authentication center includes: when verifying the first device as authorized, generating the first security credential based on the random number, the identifier of the first device, the identifier of the authentication center, and the private key of the authentication center according to an elliptic curve cryptography.

According to an embodiment, a data transmission apparatus is provided. The data transmission apparatus includes modules configured to perform the data transmission method in any one of the first aspect or the possible designs of the first aspect, or modules configured to perform the data transmission method in any one of the described aspects or embodiments. For example, the data transmission apparatus includes a communication module, an authentication module, and an encryption module.

According to an aspect, a data transmission apparatus is provided. The data transmission apparatus includes modules configured to perform the data transmission method in any one of the described aspects or embodiments. For example, the data transmission apparatus includes a communication module and a registration module.

According to an embodiment, a computer device is provided. The computer device includes at least one processor and a memory. The memory is configured to store a group of computer instructions. The processor may be used as the first device or the second device or the authentication center, in any one of the described aspects or embodiments to execute the group of computer instructions, the processor performs the operations of the data transmission method in any of the described aspects or embodiments.

According to an aspect, a communication system is provided. The communication system includes an authentication center, a first device, and a second device. The first device is configured to perform the described operations. The second device is configured to perform the described operations. The authentication center is configured to perform the described operations.

According to an aspect, a chip is provided, and includes a processor and a power supply circuit. The power supply circuit is configured to supply power to the processor. The processor is configured to perform the operations of the method in any one of the described aspects or embodiments.

According to a an aspect, a computer-readable storage medium is provided, and includes computer software instructions. When the computer software instructions are run on a computer device, the computer device is enabled to perform the operation steps of the method in any one of the described aspects or embodiments.

According to an aspect, a computer program product is provided. When the computer program product is run on a computer, the computer is enabled to perform the operation steps of the method in any one of the described aspects or embodiments.

The technical effects of any aspects or embodiment may be applicable to other aspects or embodiments. Details are not described herein again.

It should be understood that, based on the various embodiments described in the present disclosure, the embodiments in this application may be further combined to provide additional embodiments.

### BRIEF DESCRIPTION OF DRAWINGS

FIG. 1 is a diagram of an internet of things architecture according to this application;

FIG. 2 is a diagram of another internet of things architecture according to this application;

FIG. 3 is a diagram of internet of things security authentication according to this application;

FIG. 4 is a schematic flowchart of data transmission in a registration phase according to this application;

FIG. 5 is another schematic flowchart of data transmission in a registration phase according to this application;

FIG. 6 is another schematic flowchart of data transmission in a registration phase according to this application;

FIG. 7 is a schematic flowchart of data transmission in an authentication phase according to this application;

FIG. 8 is another schematic flowchart of data transmission in an authentication phase according to this application;

FIG. 9 is a schematic flowchart of key update in a management phase according to this application;

FIG. 10 is a schematic flowchart of key revocation in a management phase according to this application;

FIG. 11 is a diagram of a structure of a data transmission apparatus according to this application;

FIG. 12 is a diagram of a structure of another data transmission apparatus according to this application; and

FIG. 13 is a diagram of a structure of a computer device according to this application.

### DESCRIPTION OF EMBODIMENTS

For ease of understanding, main terms in this application are first explained.

Internet of things (IoT) is an important part of a new generation of information technology, referring to an internet that connects things. First, the core and foundation of the internet of things is still the internet, and the internet of things is a network extended and expanded based on the internet. Second, end users of the internet of things are extended and expanded to encompass information exchange and communication between any object. Therefore, the internet of things is a type of network that connects any object to the internet according to agreed protocols by using information sensing devices such as radio frequency identification, infrared sensors, global positioning systems, or laser scanners, so as to exchange information and communicate with each other, thereby implementing intelligent identification, positioning, and management of the object.

Secret key encryption is an encryption service provided to ensure network security of an open network environment. In other words, the secret key encryption is an encryption method used by a transmitter and a receiver to encrypt and decrypt plaintext using asymmetric keys or symmetric keys.

For example, symmetric key encryption, also referred to as private key encryption or shared key encryption, means that terminal devices use a same key for encryption and decryption, where the key is a common secret among the terminal devices. In comparison with asymmetric cryptography, the symmetric key encryption requires that both parties need to obtain the same key, which is one of main disadvantages of the symmetric key encryption.

For another example, asymmetric cryptography, also referred to as public key cryptography, includes a public key and a private key. The public key is used to encrypt plaintext to obtain ciphertext. The private key is used to decrypt ciphertext to obtain plaintext. Because encryption and decryption require two different keys, this manner is referred to as asymmetric cryptography. The public key can be shared to the public freely, while the private key needs to remain confidential. Based on a public key encryption characteristic, a digital signature function is further provided, allowing electronic files to achieve an equivalent effect of handwritten signatures on paper files.

To reduce network attacks on the internet of things and improve network security of the internet of things, this application provides a data transmission method. To be specific, an authentication key is generated based on a security credential distributed by an authentication center, and after mutual authentication between devices is performed based on authentication code that is generated based on the authentication key, encrypted data obtained by encrypting with an encryption key is transmitted.

For symmetric key encryption, the authentication center needs to store shared keys, and transmission of the shared keys needs to be performed between devices. The difficulty in managing shared keys and their susceptibility to being obtained make them prone to network attacks. For asymmetric key encryption, certificates and public keys occupy large network bandwidth and more storage resources. In comparison, according to the solution provided in this application, because an internet of things device performs authentication based on an authentication key generated by the internet of things device itself, transmission of the authentication key does not need to be performed between internet of things devices. This avoids the authentication key being obtained, improves security of the authentication key, and reduces network attacks. The authentication center does not need to manage the authentication key or the security credential, so that an authentication mechanism is decentralized, and complexity of key management is reduced. In addition, a data amount of the authentication key is small, and a storage requirement of an internet of things device with constrained resources is satisfied. Therefore, security authentication on the internet of things device with constrained resources is implemented, network attacks on an internet of things are reduced, and network security of the internet of things is improved.

The internet of things device described in this application may be referred to as a lightweight device or a resource-limited device, and includes an internet of things device-level device defined in IETF-RFC 7228. For example, in the internet of things device, a storage capacity of a random access memory (RAM) is less than or equal to 10 K, and a storage capacity of a read-only memory (ROM) is less than or equal to 100 K.

The data transmission method provided in this application may be applied to a network with any scale, and a network scale and a network type are not limited. For example, the network is a campus network, an internet of things, a local area network, or an internet. For ease of description, the internet of things is used as an example for description.

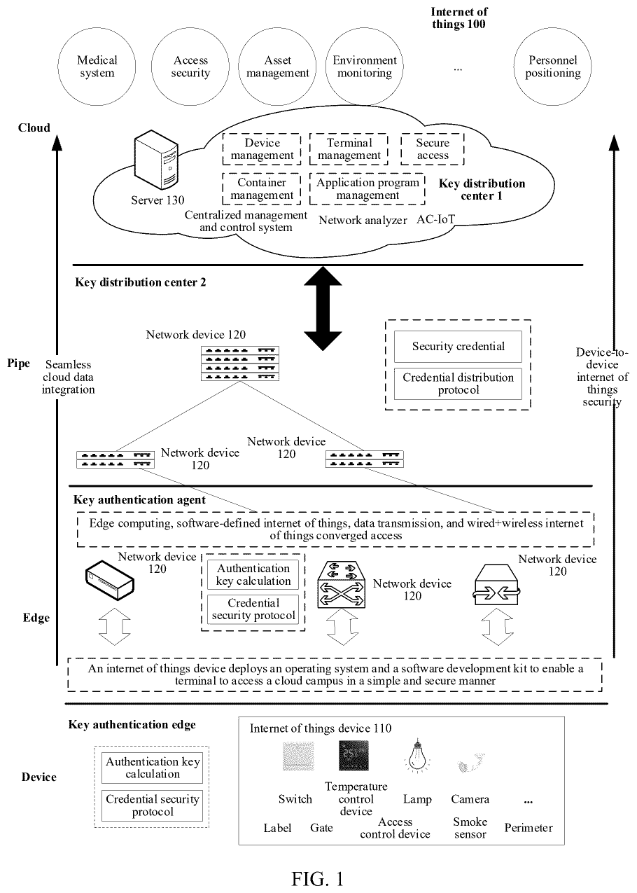

FIG. 1 is a diagram of an internet of things architecture according to this application. An internet of things in a cloud computing deployment scenario is described herein. As shown in FIG. 1, the internet of things 100 includes a device, an edge, a pipe, and a cloud. The device is configured to collect data, and the device may be used as a perception layer in the internet of things architecture. The device includes an internet of things device 110, and the internet of things device 110 includes but is not limited to terminal devices such as switches, temperature control devices, smoke sensors, lamps, labels, cameras, gates, perimeters, and access control devices.

The edge is configured to provide functions such as edge computing, a software-defined internet of things, and data transmission. For example, the edge includes infrastructure and an edge device. The pipe is configured to aggregate data and traffic and provide a transmission path for aggregated data. For example, the edge and the pipe include network devices 120. The network devices 120 include but are not limited to network switches and gateways. The edge and the pipe may be used as network layers in the internet of things architecture, and used as bridges between the end and the cloud to transmit data obtained at the perception layer to a specified destination.

The cloud may be a cloud data center, including a plurality of servers 130, configured to provide functions such as device management, terminal management, container management, application program management, and secure access. For explanations of the functions, refer to existing related descriptions. The cloud may be used as a platform layer and an application layer in the internet of things architecture. The platform layer is used for communication and operation management with devices in the internet of things. The application layer is configured to provide intelligent services based on a service field, for example, a medical system, access security, asset management, environment monitoring, and personnel monitoring.

A connection manner and link protocols of devices in the internet of things are not limited in this application. The devices in the internet of things may be connected in a wireless manner or a wired manner, to facilitate data transmission between the devices. The device link protocols include various link protocols such as Wi-Fi, an Ethernet protocol, Bluetooth, RS485, and RS232.

In this application, the cloud data center may be used as a key distribution center (KDC), and is configured to distribute a security credential to the device in the internet of things. The edge and the pipe may be used as key authentication agents (KAAs), and are configured to verify, distribute, and transmit the security credential. The device is used as a key authentication edge (KAE), and is configured to: generate an authentication key based on the security credential; and after mutual authentication between the internet of things devices is performed based on authentication code generated based on the authentication key, transmit encrypted data obtained by encrypting with an encryption key.

For example, the internet of things device 110 may deploy an operating system and a software development kit (SDK), to perform security authentication based on the solution provided in this application, to facilitate secure communication between the internet of things devices.

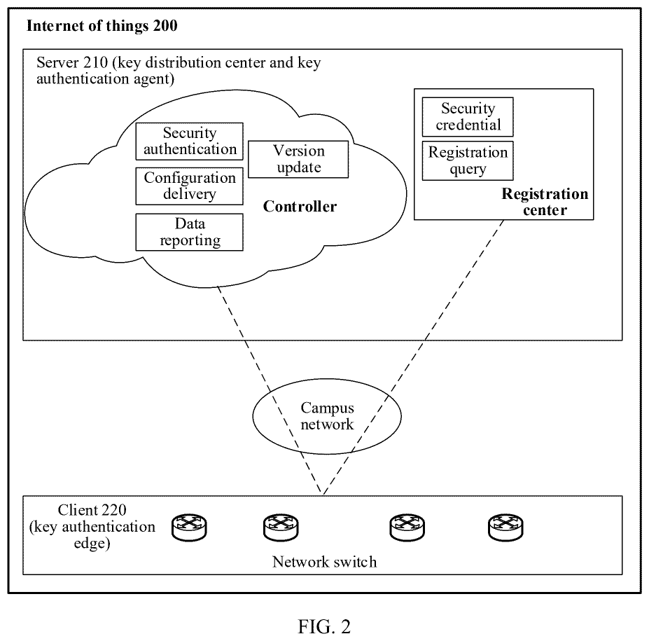

In some other embodiments, a security authentication solution provided in this application is deployed in a small campus by using a server-client (C/S) architecture. FIG. 2 is a diagram of another internet of things architecture according to this application. The internet of things 200 includes a server 210 and a client 220. Data transmission is performed between the server 210 and the client 220 based on a campus network. The server 210 integrates functions of a key distribution center and a key authentication agent. The server 210 provides functions such as security authentication, configuration delivery, data reporting, version update, and registration query. The client 220 serves as a key authentication edge and provides a function of the key authentication edge. For example, in a campus, a network switch serves as an authentication client, and a controller serves as a server, to complete two-way authentication based on the solution provided in this application, to facilitate secure communication.

The following describes in detail, with reference to the accompanying drawings, an embodiment of internet of things-based security authentication is provided in this application.

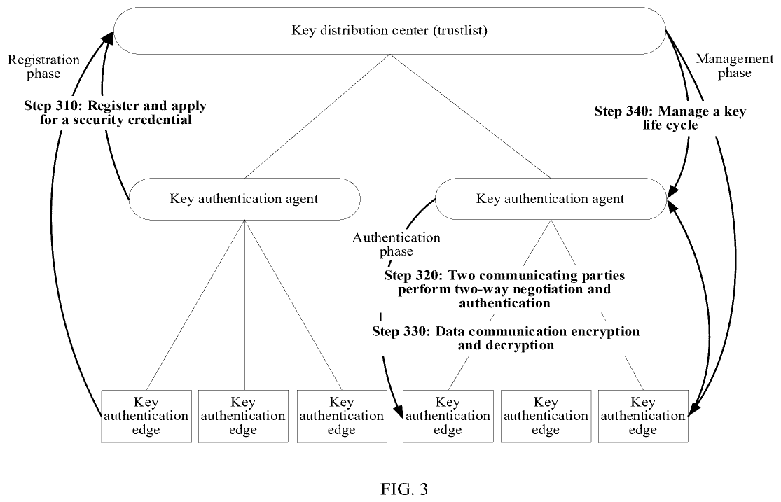

FIG. 3 is a diagram of internet of things security authentication according to this application. The internet of things security authentication includes a registration phase, an authentication phase, and a management phase.

Registration phase: Register and apply for a security credential. For example, an authentication center verifies, based on a trustlist, a device that is to access the internet of things, and the device obtains the security credential from the authentication center (operation 310) after being successfully verified by the authentication center.

Authentication phase: Two communication parties perform two-way negotiation and authentication and data communication encryption and decryption. For example, the device generates an authentication key based on the security credential, and after mutual authentication between devices is performed based on authentication code generated based on the authentication key (operation 320), the device transmits encrypted data obtained by encrypting with an encryption key (operation 330).

Management phase: Manage a key life cycle. For example, the authentication center updates a public key and a private key of the authentication center. The device updates a public key and a private key of the device (operation 340).

This application provides a certificateless lightweight authentication solution for an internet of things, which is applicable to internet of things devices with constrained resources in the internet of things. In other words, the internet of things device includes limited computing resources and limited storage resources. In this way, security authentication on the internet of things device is implemented, network attack events of the internet of things are reduced, and network security of the internet of things is improved. Problems of difficulties in key management, distribution, and maintenance, over-centralized authority of the authentication center, significant resource occupation, and low performance in a conventional authentication manner in the internet of things are solved.

The following describes the registration phase, the authentication phase, and the management phase in detail with reference to the accompanying drawings.

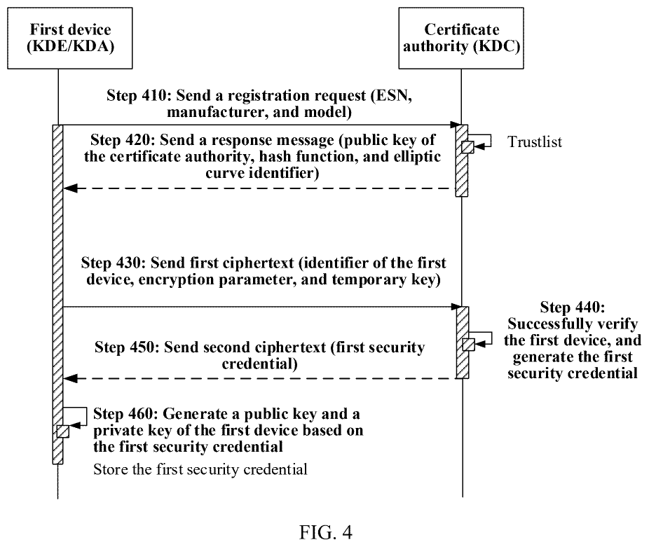

FIG. 4 is a schematic flowchart of data transmission in a registration phase according to this application. Herein, an example in which a first device accesses an authentication center is used for description. The first device may be the device serving as the key authentication agent or the key authentication edge described in FIG. 1. The authentication center may be the device serving as the key distribution center in FIG. 1. As shown in FIG. 4, the method includes the following operations.

### Operation 410: The First Device Sends a Registration Request to the Authentication Center.

The registration request includes an identifier of the first device indicative of the first device. For example, the identifier of the first device includes an electronic serial number (Electronic Serial Number, ESN), a manufacturer, a model, and the like.

### Operation 420: The Authentication Center Sends a Response Message to the First Device.

The authentication center stores a trustlist including identifiers of a plurality of devices. After receiving the registration request, the authentication center queries the trustlist. If the trustlist includes the identifier of the first device, the authentication center determines that the first device is authorized, and feeds back a response message, for example, an acknowledgement (acknowledgement, ACK), to the first device. If the trustlist does not include the identifier of the first device, the authentication center determines that the first device is unauthorized, and feeds back a response message, for example, a negative acknowledgement (non-acknowledgement, NACK), to the first device.

When the first device is authorized, the response message includes a public key of the authentication center, a hash function, and an elliptic curve identifier, so that the first device generates a public key and a private key. The public key and a private key of the authentication center may be preconfigured. The elliptic curve identifier indicates an elliptic curve, that is, a shape of the elliptic curve.

### Operation 430: The First Device Sends First Ciphertext to the Authentication Center.

After receiving the response message, the first device calculates the identifier of the first device and a random number based on the public key of the authentication center, to obtain the first ciphertext, so that the authentication center verifies the first device and feeds back a security credential.

In an embodiment, the first device calculates the identifier of the first device, the random number, and a fixed character string based on the public key of the authentication center, to obtain the first ciphertext. Therefore, a possibility that the first ciphertext is deciphered is further reduced, and security of the first ciphertext is improved.

In some embodiments, the first device sends the first ciphertext to the authentication center after the first device and the authentication center perform encryption and decryption calculation once based on the public key of the authentication center and the identifier of the first device. Therefore, security of performing a registration procedure by the authentication center is improved.

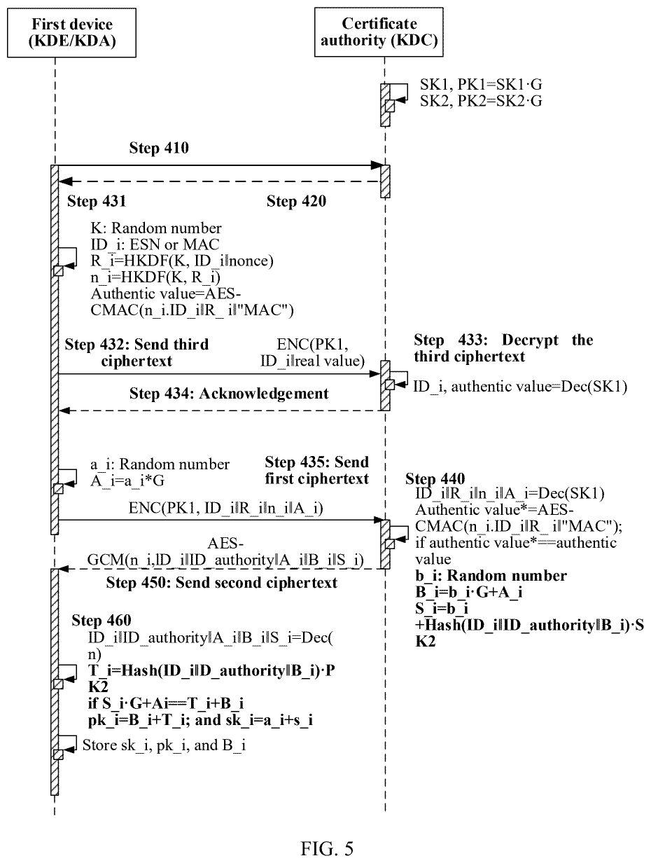

For example, as shown in FIG. 5, the first device obtains the public key of the authentication center from the authentication center. The first device calculates the identifier of the first device, an encryption parameter, and the fixed character string based on a temporary key, to obtain an authentic value (operation 431). For example, the authentic value satisfies the following Formula (1).

$$\begin{matrix}AuthenValue\_i = AES - CMAC ( n\_i . ID\_i ‖ R\_i ‖ MAC ) \\ R\_i = HKDF ( K , ID\_i ‖ nonce ) \\ n\_i = HKDF ( K , R\_i )\end{matrix} \qquad Formula ( 1 )$$

AuthenValue_i represents the authentic value. AES-CMAC and HKDF represent encryption algorithms. K represents a first random number. ID_i represents the identifier of the device. nonce and MAC represent fixed character strings. R_i represents a first encryption parameter obtained based on the first random number. n_i represents the temporary key.

The first device calculates the identifier of the first device and the authentic value based on the public key of the authentication center, to obtain third ciphertext. For example, a calculation manner of the third ciphertext is as follows: ENC(PK1, ID_illAuthenValue).

The first device sends the third ciphertext to the authentication center (operation 432), and the authentication center decrypts the third ciphertext based on the private key of the authentication center (operation 433). A decryption calculation manner of the third ciphertext is as follows: AuthenValue_i=Dec(SK1). SK1 represents the private key of the authentication center.

If the decryption succeeds, it indicates that the first device is authorized, the identifier of the first device and the authentic value are obtained, and the identifier of the first device and the authentic value are stored, to verify the first device based on the identifier of the first device and the authentic value. The authentication center feeds back an acknowledgement to the first device (operation 434).

The first device calculates the identifier of the first device, the encryption parameter, and the temporary key based on the public key of the authentication center, to obtain the first ciphertext, and sends the first ciphertext to the authentication center (operation 435). For example, a calculation manner of the first ciphertext is as follows: ENC(PK1, ID_i∥R_i∥n_i∥A_i). PK1 represents the public key of the authentication center. A_i represents a second encryption parameter obtained based on a second random number. A_i=a_i*G. a_i represents the second random number. G represents a base point of the elliptic curve.

### Operation 440: The Authentication Center Successfully Verifies the First Device, and Generates a First Security Credential.

The authentication center decrypts the first ciphertext based on the private key of the authentication center, to obtain the identifier of the first device, the encryption parameter, and the temporary key. A decryption calculation manner of the first ciphertext is as follows: ID_i∥R_i∥n_i∥A_i=Dec(SK1).

The authentication center calculates the identifier of the first device, the encryption parameter, and the fixed character string based on the temporary key obtained by decrypting the first ciphertext, to obtain the authentic value. The authentication center and the first device may preconfigure a same fixed character string.

If an authentic value generated by the authentication center is the same as the authentic value of the first device stored by the authentication center, it indicates that the first device is authorized, and the authentication center generates a security parameter of the first device (operation 440).

For example, if AuthenValue_i*==AuthenValue_i, AuthenValue_i*=AES-CMAC(n_i.ID_i∥R_i∥″MAC″). AuthenValue_i* represents the authentic value generated by the authentication center.

In some embodiments, the authentication center generates the first security credential based on the random number, the identifier of the first device, an identifier of the authentication center, and the private key of the authentication center. For example, the authentication center generates a first security parameter based on the hash function. The first security parameter satisfies the following Formula (2).

$$\begin{matrix}S\_i = b\_i + Hash ( ID\_i ‖ ID\_authority ‖ B\_i ) SK 2 \\ B\_i = b\_i \cdot G + A\_i\end{matrix} \qquad Formula ( 2 )$$

b_i represents a third random number. ID_authority represents the identifier of the authentication center. B_i and S_i represent security parameters of the first device.

The first security credential includes at least one of the identifier of the authentication center, the security parameter of the first device, the hash function, and the elliptic curve identifier.

Operation 450: The Authentication Center Sends Second Ciphertext to the First Device, where the Second Ciphertext Includes the First Security Credential.

The authentication center calculates the identifier of the first device, the identifier of the authentication center, the encryption parameter, and the security parameter of the first device based on the temporary key, to obtain the second ciphertext. For example, a calculation manner of the second ciphertext is as follows: AES-GCM(n_i,lD_i∥ID_authority∥A_i∥B_i∥S_i).

### Operation 460: The First Device Generates the Public Key and the Private Key of the First Device Based on the First Security Credential.

The first device decrypts the second ciphertext based on the temporary key, to obtain the identifier of the first device, the identifier of the authentication center, the encryption parameter, and the security parameter of the first device. A decryption calculation manner of the second ciphertext is as follows: ID_i∥ID_authority∥A_i∥B_i∥S_i=Dec(n).

In some embodiments, the first device verifies, based on the public key of the authentication center, the identifier of the first device, and the identifier of the authentication center, that the first security credential is valid, and generates the public key and the private key of the first device based on the first security credential. For example, the first device verifies the first security credential based on the hash function according to the elliptic curve cryptography, generates the public key and the private key of the first device, and stores the public key and the private key of the first device. The public key of the first device and the private key of the first device satisfy Formula (3).

$$\begin{matrix}if S\_i \cdot G + Ai == T\_i + B\_i \\ T\_i = Hash ( ID\_i ‖ D\_authority ‖ B\_i ) PK 2 \\ pk\_i = B\_i + T\_i ; and sk\_i = a\_i + s\_i\end{matrix} \qquad Formula ( 3 )$$

pk_i represents the public key of the first device. sk_i represents the private key of the first device.

In this way, after successfully verifying the first device that is to access the internet of things, the authentication center distributes the first security credential to the first device. Therefore, in the registration phase, the authentication center verifies the first device, to ensure security of distributing the security credential, and avoid distributing the security credential to an unauthorized device. In addition, the first device generates the public key and the private key of the first device according to the elliptic curve cryptography, to effectively reduce occupation of a computing resource and a storage resource of the first device, avoid transmission of the public key and the private key of the first device, reduce an obtaining risk, and improve security of the public key and the private key of the first device.

It should be noted that any device that is to access the internet of things can perform the registration procedure based on the descriptions in the foregoing embodiment, to obtain a security credential from the authentication center, so as to generate a public key and a private key based on the security credential. In the internet of things, devices store public keys and private keys of the devices, and the public keys and the private keys of the devices are different. The authentication center manages the public key and the private key of the authentication center, and does not need to manage the public key or the private key of the device, or the security credential, so that an authentication mechanism is decentralized, complexity of key management is reduced, and security of the public key and private key of the device is improved. The authentication center may configure a pair of a public key and a private key, or may configure two pairs of public keys and private keys. When the first device generates the first ciphertext and generates the public key and the private key of the first device, different public keys of the authentication center are used, to improve security of the registration procedure.

In an embodiment, as shown in FIG. 6, the public key and the private key of the authentication center may be preconfigured for the device that is to access the internet of things. After the authentication center successfully verifies the device, the response message fed back to the device may not include the public key or the private key of the authentication center, but include the hash function and the elliptic curve identifier.

After successfully registering with the authentication center, the first device may perform two-way authentication and communication with another device in the internet of things.

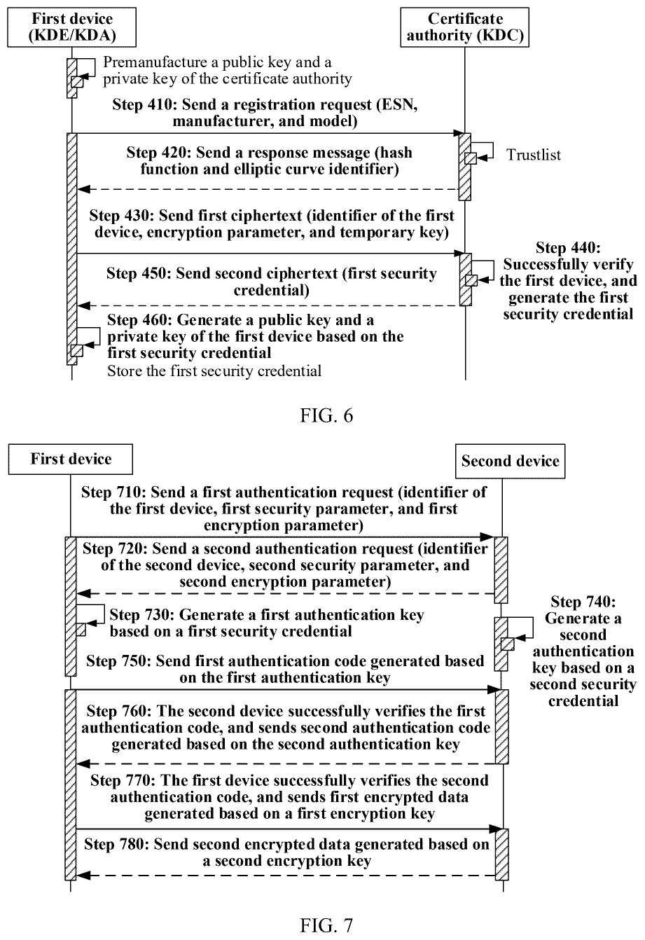

FIG. 7 is a schematic flowchart of data transmission in an authentication phase according to this application. Herein, an example in which authentication is performed between a first device and a second device for data transmission is used for description. The first device and the second device may be any devices in a network, such as the devices serving as the key authentication agents or the key authentication edges in FIG. 1. As shown in FIG. 7, the method includes the following operations.

### Operation 710: The First Device Sends a First Authentication Request to the Second Device.

The first authentication request includes parameters related to the first device, for example, an identifier of the first device, a first security parameter, and a first encryption parameter.

In an embodiment, the first authentication request may serve as payload content of a user datagram protocol (User Datagram Protocol, UDP) packet.

### Operation 720: The Second Device Sends a Second Authentication Request to the First Device.

The second authentication request includes parameters related to the second device, for example, an identifier of the second device, a second security parameter, and a second encryption parameter.

### Operation 730: The First Device Generates a First Authentication Key Based on a First Security Credential.

The first device generates the first authentication key based on the first security credential according to an elliptic curve cryptography. The elliptic curve cryptography (Elliptic curve cryptography, ECC) is a public-key encryption system. A mathematical basis of the elliptic curve cryptography relies on difficulty of calculating an elliptic discrete logarithm on an Abel additive group including rational points on an elliptic curve. Due to advantages such as high security, a high processing speed, small occupied storage space, and small occupied bandwidth, generating the authentication key according to the elliptic curve cryptography implements lightweight security authentication on an internet of things device in internet of things, and meets a resource performance requirement of the internet of things device.

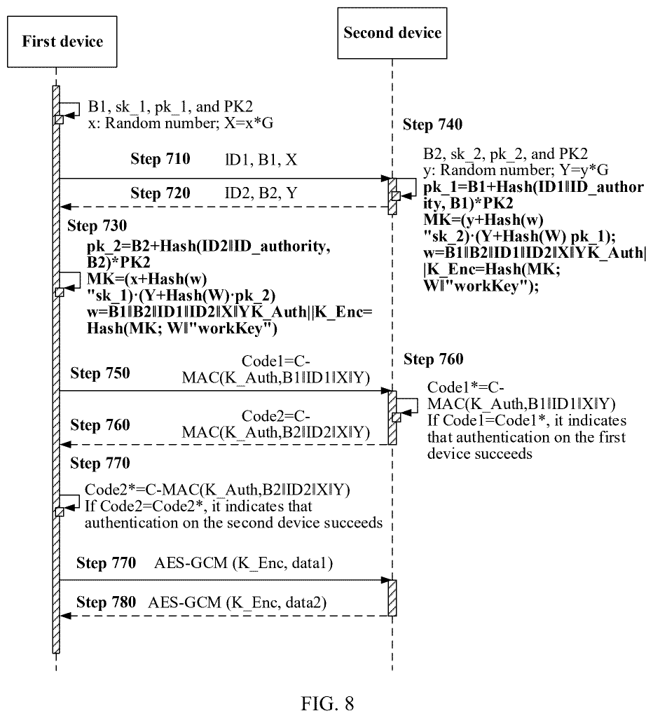

In some embodiments, the first device generates a public key of the second device based on a public key of an authentication center and the first security credential, and generates the first authentication key based on the public key of the second device and a private key of the first device. In an embodiment, when generating the first authentication key, the first device uses the identifier of the first device and a random number obtained from the first device as input parameters. For example, as shown in FIG. 8, the public key of the second device satisfies Formula (4), and the first authentication key satisfies Formula (5).

$$pk\_ 2 = B 2 + Hash ( ID 2 ‖ ID\_authority , B 2 ) * PK 2 \qquad Formula ( 4 )$$

$$\begin{matrix}K\_Auth = Hash ( MK ; W ‖ workKey ) \\ MK = ( x + Hash ( w ) \text{"sk\_1)(} Y \text{+Hash(} W \text{)·pk\_2)} \\ w = B 1 ‖ B 2 ‖ ID 1 ‖ ID 2 ‖ X ‖ Y\end{matrix} \qquad Formula ( 5 )$$

pk_2 represents the public key of the second device. B2 represents the second security parameter. ID2 represents the identifier of the second device. PK2 represents the public key of the authentication center. sk_1 represents the private key of the first device. B1 represents the first security parameter. ID1 represents the identifier of the first device. X and Y represent encryption parameters, X=x*G, Y-y*G, where x represents a fourth random number, and y represents a fifth random number.

In an embodiment, the first device generates a first encryption key according to Formula (5). K_Enc=Hash(MK; W∥“workKey”).

### Operation 740: The Second Device Generates a Second Authentication Key Based on a Second Security Credential.

The second device generates the second authentication key based on the second security credential according to the elliptic curve cryptography. For specific explanations of the second device obtaining the second security credential from the authentication center, and generating the public key and a private key of the second device based on the second security credential, refer to the foregoing explanations of the registration procedure. Details are not described again.

The second device generates the public key of the first device based on the public key of the authentication center and the second security credential, and generates the second authentication key based on the public key of the first device and the private key of the second device. In an embodiment, when generating the second authentication key, the second device uses the identifier of the second device and a random number obtained from the second device as input parameters. For example, as shown in FIG. 8, the public key of the first device satisfies Formula (6), and the second authentication key satisfies Formula (7).

$$pk\_ 1 = B 1 + Hash ( ID 1 ‖ ID\_authority , B 1 ) * PK 2 \qquad Formula ( 6 )$$

$$\begin{matrix}K\_Auth = Hash ( MK ; W ‖ workKey ) \\ MK = ( y + Hash ( w ) \text{"sk\_2)(} Y \text{+Hash(} W \text{)·pk\_1)} \\ w = B 1 ‖ B 2 ‖ ID 1 ‖ ID 2 ‖ X ‖ Y\end{matrix} \qquad Formula ( 7 )$$

pk_1 represents the public key of the first device. sk_2 represents the private key of the second device.

In an embodiment, the second device generates a second encryption key according to Formula (5). K_Enc=Hash(MK; W∥“workKey”).

### Operation 750: The First Device Sends, to the Second Device, First Authentication Code Generated Based on the First Authentication Key.

The first device calculates the identifier of the first device and the random number based on the first authentication key, to generate the first authentication code. Because the random number is used as an input parameter for generating the authentication code, security of the authentication code can be improved. Because an attack device may fail to obtain the random number, authentication code generated by the attack device may fail to be identified, in other words, the authentication code is invalid data. The first authentication code satisfies the following Formula (8).

$$Code 1 = C - MAC ( K\_Auth , B 1 ‖ ID 1 ‖ X ‖ Y \qquad Formula ( 8 )$$

Code1 represents the first authentication code. C-MAC represents an encryption algorithm. K_Auth represents the first authentication key.

### Operation 760: The Second Device Successfully Verifies the First Authentication Code, and Sends, to the First Device, Second Authentication Code Generated Based on the Second Authentication Key.

The second device may generate first verification code based on the second authentication key by using a method for generating the first authentication code by the first device, and verify whether the first authentication code is valid. For example, the second device determines whether the first verification code is the same as the first authentication code. When the first verification code is the same as the first authentication code, it is determined that the first device is successfully authenticated, indicating that the first authentication code is valid. When the first verification code is different from the first authentication code, it is determined that authentication on the first device fails, indicating that the first authentication code is invalid. For example, if the first device is an attack device, the first authentication key generated by the first device may be incorrect, resulting in a failure of the authentication. The second authentication code satisfies the following Formula (9).

$$Code {1}^{*} = C - MAC ( K\_Auth , B 1 ‖ ID 1 ‖ X ‖ Y \qquad Formula ( 9 )$$

Code1* represents the first verification code. K_Auth represents the second authentication key. If Code1=Code1*, it indicates that the authentication on the first device succeeds.

After the authentication on the first device succeeds, the second device calculates the identifier of the first device and the random number based on the second authentication key, to generate the second authentication code. The second authentication code satisfies the following Formula (10).

$$Code 2 = C - MAC ( K\_Auth , B 2 ‖ ID 2 ‖ X ‖ Y \qquad Formula ( 10 )$$

Code2 represents the second authentication code. C-MAC represents the encryption algorithm. K_Auth represents the second authentication key.

### Operation 770: The First Device Successfully Verifies the Second Authentication Code, and Sends, to the Second Device, First Encrypted Data Generated Based on the First Encryption Key.

The first device may generate second verification code based on the first authentication key by using a method for generating the second authentication code by the second device, and verify whether the second authentication code is valid. For example, the second device determines whether the second verification code is the same as the second authentication code. When the second verification code is the same as the second authentication code, it is determined that authentication on the second device succeeds, indicating that the second authentication code is valid. When the second verification code is different from the second authentication code, it is determined that authentication on the second device fails, indicating that the second authentication code is invalid. For example, if the second device is an attack device, the second authentication key generated by the second device may be incorrect, resulting in a failure of the authentication. The second verification code satisfies the following Formula (11).

$$Code {2}^{*} = C - MAC ( K\_Auth , B 2 ‖ ID 2 ‖ X ‖ Y \qquad Formula ( 11 )$$

Code2* represents the second verification code. K_Auth represents the first authentication key. If Code2=Code2*, it indicates that the authentication on the second device succeeds.

A calculation method of the first encrypted data is as follows: AES-GCM(K_Enc, data1). K_Enc represents the first encryption key.

### Operation 780: The Second Device Sends, to the First Device, Second Encrypted Data Generated Based on the Second Encryption Key.

A calculation method of the second encrypted data is as follows: AES-GCM(KFEnc, data2). K_Enc represents the second encryption key.

In this way, the first device and the second device generate a public key of each other based on the hash function according to the elliptic curve cryptography, and generate the authentication key based on the public key of each other. In other words, a same authentication key is generated based on different input parameters according to an asymmetric encryption algorithm. Transmission of the public key and the authentication key does not need to be performed between the devices, to avoid obtaining of the public key and the authentication key by an unauthorized device, and improve security of the public key and the authentication key. Two-way authentication is completed between the first device and the second device based on the authentication key, a data amount of ciphertext is small, and occupied bandwidth is reduced. Therefore, security authentication on an internet of things device with constrained resources is implemented, network attacks on the internet of things are reduced, and network security of the internet of things is improved.

In an embodiment, when a device in the internet of things accesses a network for a non-first time, for example, when the device is restarted, the device does not need to register with the authentication center again, and only needs to perform mutual authentication with a device that needs to communicate with the device, thereby improving performance of mutual authentication between the devices.

In addition, according to the solution provided in this application, there is no need to add a device to the internet of things, modify hardware, or increase a memory capacity. This reduces deployment costs. An SDK manner of terminal software may be used for configuration. This is simple and easy to deploy.

After the device in the internet of things is successfully registered with the authentication center, the authentication center may manage a key life cycle in a system. Key update is an important part of key management and is a procedure of replacing an old key with a new key.

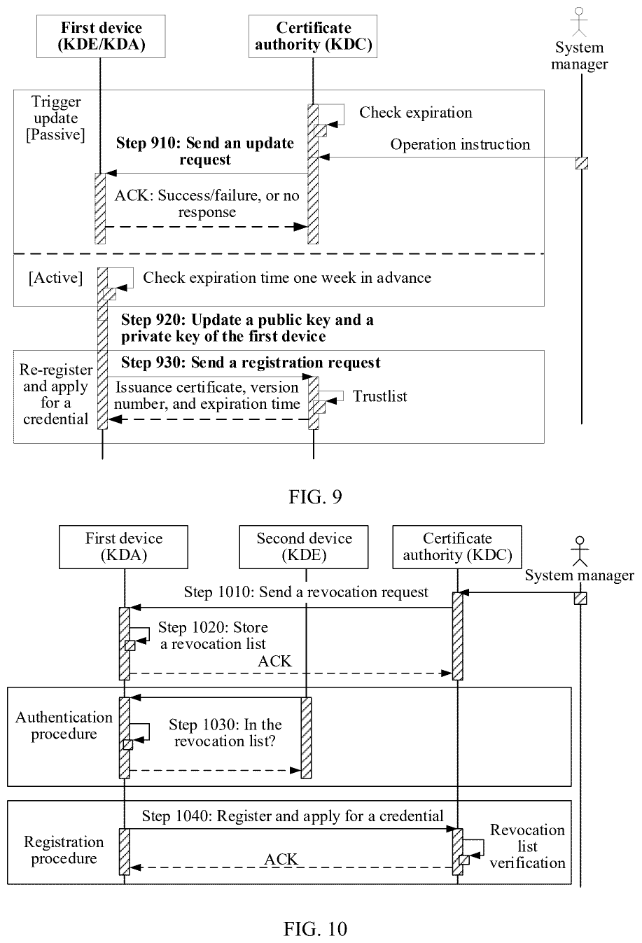

FIG. 9 is a schematic flowchart of key update in a management phase according to this application. Herein, an example in which a first device updates a key is used for description. An authentication center may serve as a key distribution center. The first device may be serve as a key authentication agent or a key authentication edge. As shown in FIG. 9, the method includes the following operations.

### Operation 910: The Authentication Center Sends an Update Request to the First Device.

The authentication center may send the update request to the first device based on an operation instruction of a system administrator. Alternatively, the authentication center may periodically send the update request to the first device. The update request indicates to update a security credential.

For example, the authentication center may periodically update a public key and a private key of the authentication center. The authentication center sends an updated security credential to the first device. An update period may be five years, and the update may be performed one month in advance. The first device generates an updated public key and an updated private key based on the updated security credential, to implement update of a public key and a private key of the first device.

The authentication center may record a version number of the security credential, to support credential update. Before version number rollover, devices automatically re-negotiate.

### Operation 920: The First Device Updates the Public Key and the Private Key of the First Device.

The first device may update the public key and the private key of the first device based on the update request of the authentication center. Alternatively, the first device periodically updates the public key and the private key of the first device. An update period may be one year, and the update may be performed one week in advance.

### Operation 930: The First Device Sends a Registration Request to the Authentication Center.

After updating the public key and the private key of the first device, the first device re-registers with the authentication center. For a specific explanation of a registration procedure, refer to the explanations in the foregoing embodiment. Details are not described again.

In this way, based on a key update mechanism, a key is updated before a life cycle of the key ends, or when it is known or suspected that the key is leaked, to improve security of the public key and the private key of the device, the security credential, an authentication key, and an encryption key in an internet of things.

FIG. 10 is a schematic flowchart of key revocation in a management phase according to this application. Herein, an example in which a first device updates a key is used for description. An authentication center may serve as a key distribution center. The first device may serve as a key authentication agent, and a second device may serve as a key authentication edge. As shown in FIG. 10, the method includes the following operations. The authentication center sends a revocation request to the first device, where the revocation request includes an identifier of the first device, a public key of the authentication center, and a revocation list (operation 1010). In an embodiment, the authentication center sends the revocation request to the first device based on an operation instruction of a system administrator. The first device stores the revocation list and the public key of the authentication center (operation 1020). When performing an authentication procedure, the first device checks whether an identifier of the second device is in the revocation list. If the identifier of the second device is in the revocation list, authentication on the second device fails; or if the identifier of the second device is not in the revocation list, authentication on the second device succeeds (operation 1030). When performing a registration procedure, the first device sends a registration request to the authentication center, and the authentication center checks whether the identifier of the first device is in the revocation list. If the identifier of the first device is in the revocation list, registration of the first device fails; or if the identifier of the first device is not in the revocation list, registration of the first device succeeds (operation 1040). In the registration procedure, a credential application procedure, and a session establishment procedure, whether a device has been revoked needs to be checked, to avoid using of a revoked security credential for authentication.

In an embodiment, a protocol based on which a packet is forwarded in the registration procedure, the authentication procedure, and the management procedure in this application may be a certificateless public key cryptography over the constrained application protocol (Certificateless Public Key Cryptography over The Constrained Application Protocol, CLPKC over CoAP) or an alternative interactive protocol.

It may be understood that, to implement functions in the foregoing embodiment, the device includes a corresponding hardware structure and/or software module for performing the functions. A person skilled in the art should be easily aware that, in this application, the units and method operations in the examples described with reference to embodiments disclosed in this application can be implemented by hardware or a combination of hardware and computer software. Whether a function is performed by hardware or hardware driven by computer software depends on particular application scenarios and design constraint conditions of the technical solutions.

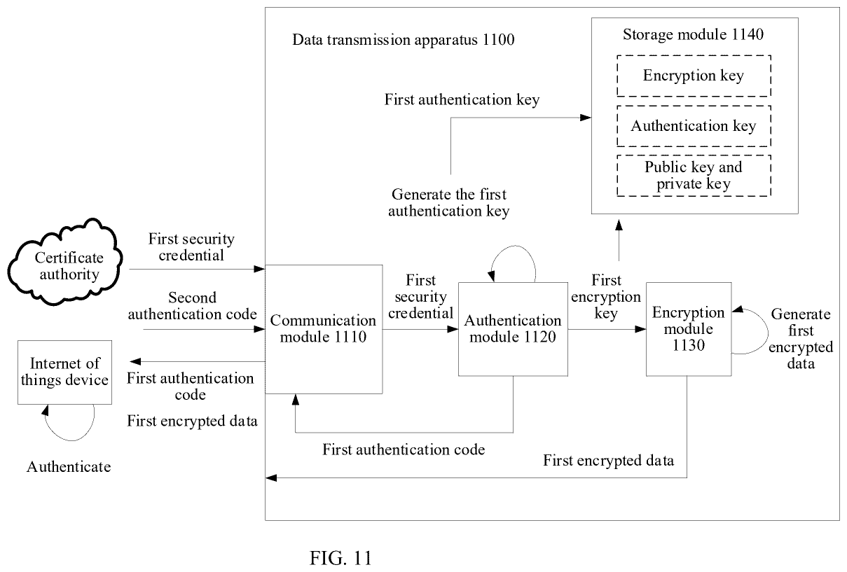

The foregoing describes, with reference to FIG. 1 to FIG. 10, in detail the data transmission method provided in this application. The following describes, with reference to FIG. 11, a data transmission apparatus provided in this application.

FIG. 11 is a diagram of a structure of a possible data transmission apparatus according to this application. The data transmission apparatus may be configured to implement a function of the device in the internet of things in the foregoing method embodiments. Therefore, the data transmission apparatus can also implement beneficial effects of the foregoing method embodiments. In this embodiment, the data transmission apparatus may be the device shown in FIG. 4 or FIG. 7, or may be a module (for example, a chip) used in a server.

As shown in FIG. 11, the data transmission apparatus 1100 includes a communication module 1110, an authentication module 1120, an encryption module 1130, and a storage module 1140. The data transmission apparatus 1100 is configured to implement a function of the first device or the second device in the method embodiment shown in FIG. 4 or FIG. 7.

The data transmission apparatus 1100 is configured to implement the function of the first device in the method embodiment shown in FIG. 4 or FIG. 7.

The communication module 1110 is configured to obtain a first security credential from an authentication center. For example, the communication module 1110 is configured to perform operation 410, operation 430, and operation 460 in FIG. 4.

The authentication module 1120 is configured to generate a first authentication key based on the first security credential, and generate first authentication code based on the first authentication key. For example, the authentication module 1120 is configured to perform operation 710, operation 730, and operation 750 in FIG. 7.

The encryption module 1130 is configured to: after the first authentication code is successfully authenticated by a second device, process to-be-transmitted data based on a first encryption key, to obtain first encrypted data. For example, the encryption module 1130 is configured to perform operation 770 in FIG. 7.

The data transmission apparatus 1100 is configured to implement the function of the second device in the method embodiment shown in FIG. 4 or FIG. 7.

The communication module 1110 is configured to receive first authentication code sent by a first device and a second security credential sent by an authentication center. For example, the communication module 1110 is configured to perform operation 410, operation 430, and operation 460 in FIG. 4.

The authentication module 1120 is configured to generate a second authentication key based on the second security credential; generate first verification code based on the second authentication key; and when the first verification code is the same as the first authentication code, determine that the first device is successfully authenticated. For example, the authentication module 1120 is configured to perform operation 740 and operation 760 in FIG. 7.

The encryption module 1130 is configured to: after the second authentication code is successfully authenticated by the first device, process to-be-transmitted data based on a second encryption key, to obtain second encrypted data. For example, the encryption module 1130 is configured to perform operation 780 in FIG. 7.

In an embodiment, the authentication module 1120 is specifically configured to: generate a first authentication key based on a first security credential according to an elliptic curve cryptography, and generate the second authentication key based on the second security credential.

The storage module 1140 is configured to store an encryption key, a public key, a private key, and an authentication key, to perform two-way authentication with a device in an internet of things based on the authentication key.

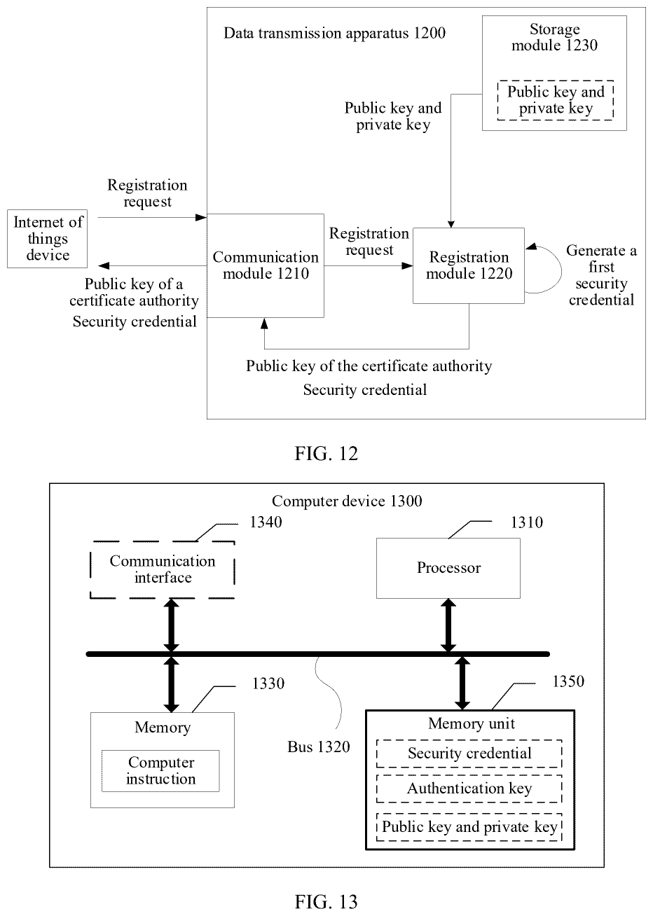

FIG. 12 is a diagram of a structure of a possible data transmission apparatus according to this application. The data transmission apparatus may be configured to implement a function of the authentication center in the internet of things in the foregoing method embodiments. Therefore, the data transmission apparatus can also implement beneficial effects of the foregoing method embodiments. In this embodiment, the data transmission apparatus may be the device shown in FIG. 4, or may be a module (for example, a chip) used in a server.

As shown in FIG. 12, the data transmission apparatus 1200 includes a communication module 1210, a registration module 1220, and a storage module 1230. The data transmission apparatus 1200 is configured to implement the function of the authentication center in the method embodiment shown in FIG. 4.

The communication module 1210 is configured to receive a registration request, and feed back a public key and a security credential of the authentication center. For example, the communication module 1210 is configured to perform operation 420 and operation 450 in FIG. 4.

The registration module 1220 is configured to generate a first security credential based on a random number, an identifier of a first device, an identifier of the authentication center, and a private key of the authentication center. For example, the registration module 1220 is configured to perform operation 460 in FIG. 4.

In an embodiment, the registration module 1220 is specifically configured to: when verifying the first device as authorized, generate the first security credential based on the random number, the identifier of the first device, the identifier of the authentication center, and the private key of the authentication center.

The storage module 1230 is configured to store the public key and the private key of the authentication center.

It should be understood that the data transmission apparatus 1100 and the data transmission apparatus 1200 in embodiments of this application may be implemented by using an application-specific integrated circuit (ASIC) or a programmable logic device (PLD). The PLD may be a complex programmable logical device (CPLD), a field programmable gate array (FPGA), a generic array logic (GAL), or any combination thereof. Alternatively, when the method shown in FIG. 4 or FIG. 7 may be implemented by using software, the modules of the data transmission method may also be software modules. The data transmission apparatus 1100, the data transmission apparatus 1200, and the modules of the data transmission apparatus 1100 and the data transmission apparatus 1200 may also be software modules.

The data transmission apparatus 1100 and the data transmission apparatus 1200 according to embodiments of this application may correspondingly perform the methods described in embodiments of this application, and the foregoing and other operations and/or functions of the units in the data transmission apparatus 1100 and the data transmission apparatus 1200 are respectively used to implement corresponding procedures of the methods in FIG. 4 or FIG. 7. For brevity, details are not described herein again.

FIG. 13 is a diagram of a structure of a computer device 1300 according to this application. As shown in FIG. 13, the computer device 1300 includes a processor 1310, a bus 1320, a memory 1330, a communication interface 1340, and a memory unit 1350 (which may also be referred to as a main memory unit). The processor 1310, the memory 1330, the memory unit 1350, and the communication interface 1340 are connected through the bus 1320.

It should be understood that, in this embodiment, the processor 1310 may be a CPU, or the processor 1310 may be another general-purpose processor, a digital signal processor (DSP), an ASIC, an FPGA or another programmable logical device, a discrete gate or a transistor logical device, a discrete hardware component, or the like. The general-purpose processor may be a microprocessor, any conventional processor, or the like.

Alternatively, the processor may be a graphics processing unit (GPU), a neural network processing unit (NPU), a microprocessor, an ASIC, or one or more integrated circuits configured to control program execution in the solutions of this application.

The communication interface 1340 is configured to implement communication between the computer device 1300 and an external device or component. In this embodiment, when the computer device 1300 is configured to implement a function of the device in the internet of things shown in FIG. 4 or FIG. 7, the communication interface 1340 is configured to obtain a security credential, so that the processor 1310 performs two-way authentication with the device in the internet of things based on the authentication key.

The bus 1320 may include a path, configured to transfer information between the foregoing components (such as the processor 1310, the memory unit 1350, and the memory 1330). In addition to a data bus, the bus 1320 may further include a power bus, a control bus, a status signal bus, and the like. However, for clear description, various types of buses are marked as the bus 1320 in the figure. The bus 1320 may be a peripheral component interconnect express (PCIe) bus, an extended industry standard architecture (EISA) bus, a unified bus (Ubus or UB), a compute express link (CXL), cache coherent interconnect for accelerators (CCIX), or the like. The bus 1320 may be classified into an address bus, a data bus, a control bus, and the like.

In an example, the computer device 1300 may include a plurality of processors. The processor may be a multi-core (multi-CPU) processor. The processor herein may be one or more devices, circuits, and/or computing units configured to process data (for example, computer program instructions).

It should be noted that, in FIG. 13, only an example in which the computer device 1300 includes one processor 1310 and one memory 1330 is used. Herein, the processor 1310 and the memory 1330 each indicate a type of component or device. In a specific embodiment, a quantity of components or devices of each type may be determined based on a service requirement.

The memory unit 1350 may be a volatile memory pool or a non-volatile memory pool, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. Through an example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). The memory unit 1350 is configured to store information such as a security credential, a public key, a private key, an authentication key, and an encryption key.

The memory 1330 may correspond to a storage medium configured to store information such as an elliptic curve cryptography and a hash algorithm in the foregoing method embodiments, for example, a magnetic disk, such as a mechanical hard disk drive or a solid-state drive.

The computer device 1300 may be a general-purpose device or a dedicated device. For example, the computer device 1300 may be an edge device (for example, a box carrying a chip with a processing capability), or the like. In an embodiment, the computer device 1300 may alternatively be a server or another device having a computing capability.

It should be understood that the computer device 1300 according to this embodiment may correspond to the data transmission apparatus 1100 or the data transmission apparatus 1200 in this embodiment, and may correspond to a corresponding entity for performing any method in FIG. 4 or FIG. 7. In addition, the foregoing and other operations and/or functions of the modules in the data transmission apparatus 1100 or the data transmission apparatus 1200 are respectively used to implement corresponding procedures of the methods in FIG. 4 or FIG. 7. For brevity, details are not described herein again.

An embodiment of this application provides a chip, including a processor and a power supply circuit. The power supply circuit is configured to supply power to the processor, and the processor is configured to perform the operations of the data processing method in the foregoing method embodiments.

The method in embodiments may be implemented in a hardware manner, or may be implemented by executing software instructions by a processor. The software instructions may include a corresponding software module. The software module may be stored in a random access memory (RAM), a flash memory, a read-only memory (ROM), a programmable read-only memory (PROM), an erasable programmable read-only memory (EPROM), an electrically erasable programmable read-only memory (EEPROM), a register, a hard disk drive, a removable hard disk drive, a CD-ROM, or any other form of storage medium well-known in the art. For example, a storage medium is coupled to the processor, so that the processor can read information from the storage medium and write information into the storage medium. Certainly, the storage medium may be a component of the processor. The processor and the storage medium may be disposed in an ASIC. In addition, the ASIC may be located in a computing device. Certainly, the processor and the storage medium may alternatively exist in the computing device as discrete components.

All or some of the foregoing embodiments may be implemented by using software, hardware, firmware, or any combination thereof. When software is used to implement embodiments, all or some of embodiments may be implemented in the form of a computer program product. The computer program product includes one or more computer programs or instructions. When the computer programs or the instructions are loaded and executed on a computer, the procedures or functions in embodiments of this application are all or partially executed. The computer may be a general-purpose computer, a dedicated computer, a computer network, a network device, user equipment, or another programmable apparatus. The computer program or instructions may be stored in a computer-readable storage medium, or may be transmitted from a computer-readable storage medium to another computer-readable storage medium. For example, the computer program or instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk drive, or a magnetic tape, may be an optical medium, for example, a digital video disc (DVD), or may be a semiconductor medium, for example, a solid-state drive (SSD). The foregoing descriptions are merely specific embodiments of this application, but are not intended to limit the protection scope of this application. Any modification or replacement readily figured out by a person skilled in the art within the technical scope disclosed in this application shall fall within the protection scope of this application. Therefore, the protection scope of this application shall be subject to the protection scope of the claims.

1. A data transmission method, comprising:
obtaining a security credential from an authentication center;
generating an authentication key based on the security credential;
generating an authentication code based on the authentication key;
after the authentication code is authenticated by a second device, processing to-be-transmitted data based on an encryption key, to obtain encrypted data; and
sending the encrypted data.

2. The method according to claim 1, wherein the method further comprises:
generating the encryption key based on the security credential.

3. The method according to claim 1, wherein generating the authentication key based on the security credential comprises:
according to an elliptic curve cryptography, generating the authentication key based on the security credential.

4. The method according to claim 1, wherein generating the authentication key based on the security credential comprises:
generating a public key of the second device based on a public key of the authentication center and the security credential; and
generating the authentication key based on the public key of the second device and a private key of a first device.

5. The method according to claim 1, wherein generating the authentication code comprises:
calculating an identifier of the first device and a random number based on the authentication key.

6. The method according to claim 1, wherein the security credential comprises at least one of an identifier of the authentication center, a security parameter, a hash function, or an elliptic curve identifier.

7. The method according to claim 1, wherein the method further comprises:
verifying the security credential as valid; and,
when the security credential is valid, generating a public key and a private key of the first device based on the security credential.

8. The method according to claim 7, wherein
verifying the security credential as valid is performed based on a public key of the authentication center, an identifier of the first device, and an identifier of the authentication center.

9. The method according to claim 1, wherein the method further comprises:
updating a public key and a private key of the authentication center;
and/or
updating a public key and a private key of the first device.

10. A first device, wherein comprises:
a memory comprising instructions;
at least one processor, when the instructions executed by the at least one processor, cause the first device to:
obtain a security credential from an authentication center;
generate an authentication key based on the security credential;
generate authentication code based on the authentication key;
after the authentication code is authenticated by a second device, process to-be-transmitted data based on an encryption key, to obtain encrypted data; and
send the encrypted data to the second device.

11. The first device according to claim 10, wherein when the instructions executed by the at least one processor, further cause the first device to:
generate the encryption key based on the security credential.

12. The first device according to claim 10, wherein when the instructions executed by the at least one processor, cause the first device to:
according to an elliptic curve cryptography, generate the authentication key based on the security credential.

13. The first device according to claim 10, wherein when the instructions executed by the at least one processor, cause the first device to:
generate a public key of the second device based on a public key of the authentication center and the security credential; and
generate the authentication key based on the public key of the second device and a private key of a first device.

14. The first device according to claim 10, wherein to generate the authentication code comprises to:
calculate an identifier of the first device and a random number based on the authentication key.

15. The first device according to claim 10, wherein the security credential comprises at least one of an identifier of the authentication center, a security parameter, a hash function, and an elliptic curve identifier.

16. The first device according to claim 10, wherein the first device is further caused to:
verify the security credential as valid; and
when the security credential is valid, generate a public key and a private key of the first device based on the security credential.

17. The first device according to claim 16, wherein
to verify the security credential as valid is performed based on a public key of the authentication center, an identifier of the first device, and an identifier of the authentication center.

18. The first device according to claim 10, wherein the first device is further caused to:
update a public key and a private key of the authentication center;
or
update a public key and a private key of the first device.

19. A non-transitory computer readable medium, storing instructions that, when executed by a processor of a first device, configures the first device to:
obtain a security credential from an authentication center;
generate an authentication key based on the security credential;
generate an authentication code based on the authentication key;
after the authentication code is authenticated by a second device, process to-be-transmitted data based on an encryption key, to obtain encrypted data; and
send the encrypted data.

20. The non-transitory computer readable medium according to claim 19, wherein the first device is further configured to:
generate the encryption key based on the first security credential.
